(19) United States
(12) Patent Application Publication
(10) Pub. No.: US 2005/0194232 A1
(43) Pub. Date: Sep. 8, 2005

(54) Modular support system for moving components

(76) Inventor: Steve William Taylor, Fort Saskatchewan (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/793,507

(22) Filed: Mar. 4, 2004

(51) Int. Cl. B65G 13/02

(52) U.S. Cl. 193/35 MD

(57) ABSTRACT

A modular support system for moving components which includes a pair of rotating support rolling elements. A single rotating primary rolling element is supported by the support rolling elements. A retainer is provided which is adapted to facilitate rolling element rotation while maintaining relative positioning of the support roller elements and the primary rolling element. This forms a triangular rolling element module. An engagement surface of the primary rolling element is accessible for engagement with a moving body.

### FIELD OF THE INVENTION

The present invention relates to a modular support system for moving components, such as rotating shafts or linear conveyors.

### BACKGROUND OF THE INVENTION

Many machines have moving components. These moving components must be supported. One example of such a moving component is a rotating shaft, which rotates within a fixed housing. Another example of such a moving component is a rotating housing, which rotates about a fixed shaft. Another example of a moving component is a linear conveyor. There are, of course, numerous other examples. While there are numerous bearing and support systems; few, if any, can be described as modular. Were a modular support system developed for moving bodies, it would facilitate ease of assembly during fabrication and change out during servicing.

### SUMMARY OF THE INVENTION

What is required is a modular support system for moving components.

According to the present invention there is provided a modular support system for moving components which includes a pair of rotating support rolling elements. A single rotating primary rolling element is supported by the support rolling elements. A retainer is provided which is adapted to facilitate rolling element rotation while maintaining relative positioning of the support roller elements and the primary rolling element. This forms a triangular rolling element module. An engagement surface of the primary rolling element is accessible for engagement with a moving body.

The triangular rolling element modules, as described above, facilitate installation during assembly and change out during servicing. The rotation of the primary rolling element on the support rolling elements is met with relatively little resistance, making the triangular rolling element modules suitable for high speed applications.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is perspective view of a modular support system for moving components constructed in accordance with the teachings of the present invention, in an application in which the modular support system engages an outside surface of a rotating component.

FIG. 2 is an end elevation view of the modular support system for moving components illustrated in FIG. 1.

FIG. 3 is a section view of the modular support system for moving components, taken along section lines A-A of FIG. 2.

FIG. 4 is perspective view of a modular support system for moving components constructed in accordance with the teachings of the present invention, in an application in which the modular support system engages an inside surface of a rotating tubular component.

FIG. 5 is an end elevation view of the modular support system for moving components illustrated in FIG. 4.

FIG. 6 is a section view of the modular support system for moving components, taken along section lines A-A of FIG. 5.

FIG. 7 is perspective view of a modular support system for moving components constructed in accordance with the teachings of the present invention, in an application supporting a component moving in a linear fashion.

FIG. 8 is a side elevation view of the modular support system for moving components illustrated in FIG. 7.

FIG. 9 is a side elevation view, in section, of the modular support system for moving components illustrated in FIG. 7.

FIG. 10 is a section view of the modular support system for moving components, taken along section lines A-A of FIG. 9.

FIG. 11 is a cut away perspective view of the modular support system for moving components, utilizing rollers oriented to withstanding radial loading.

FIG. 12 is a side elevation view of the modular support system for moving components illustrated in FIG. 11.

FIG. 13 is a section view of the modular support system for moving components, taken along section lines A-A of FIG. 12.

FIG. 14 is a cut away perspective view of the modular support system for moving components, utilizing rollers oriented to withstand axial loading.

FIG. 15 is a side elevation view of the modular support system for moving components illustrated in FIG. 14.

FIG. 16 is a cut away perspective view of the modular support system for moving components, utilizing rollers.

FIG. 17 is a side elevation view of the modular support system for moving components illustrated in FIG. 16

FIG. 18. is a section view of the modular support system for moving components, taken along section lines A-A of FIG. 17

### DETAILED DESCRIPTION OF THE PREFERRED EMBODIMENT

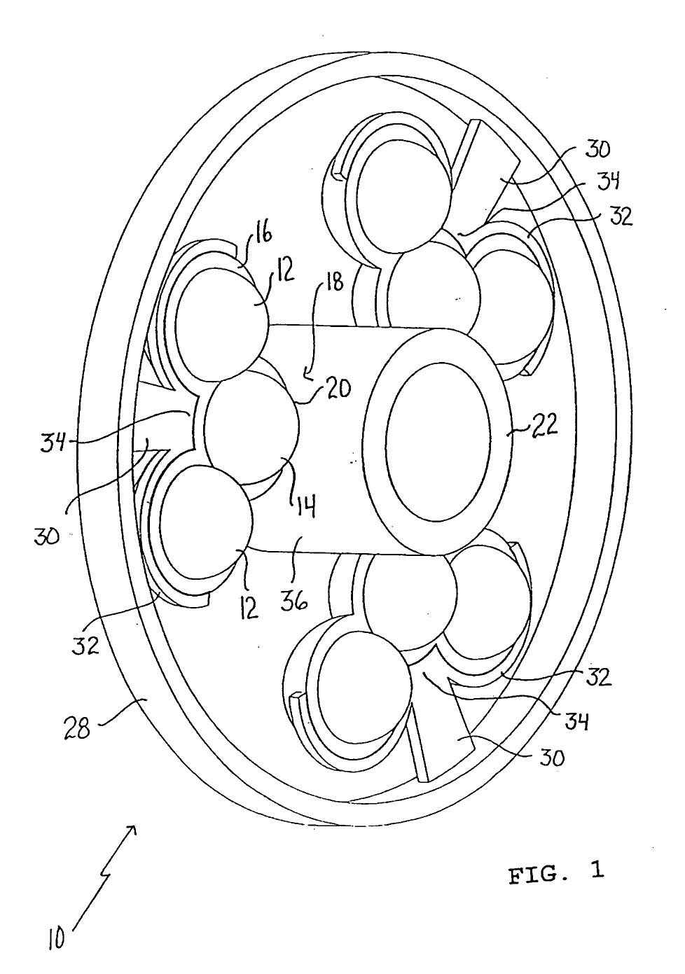

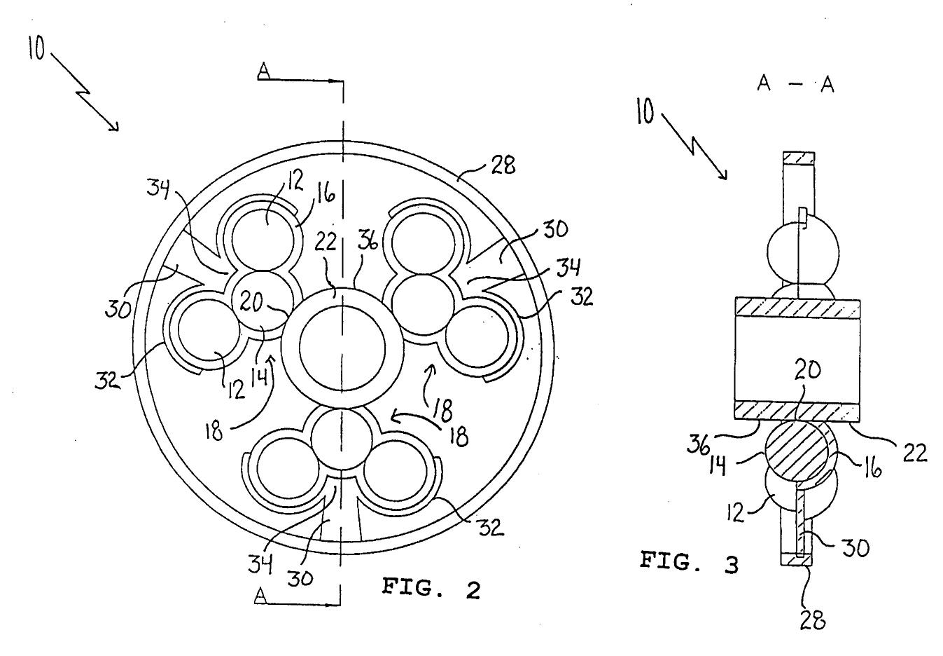

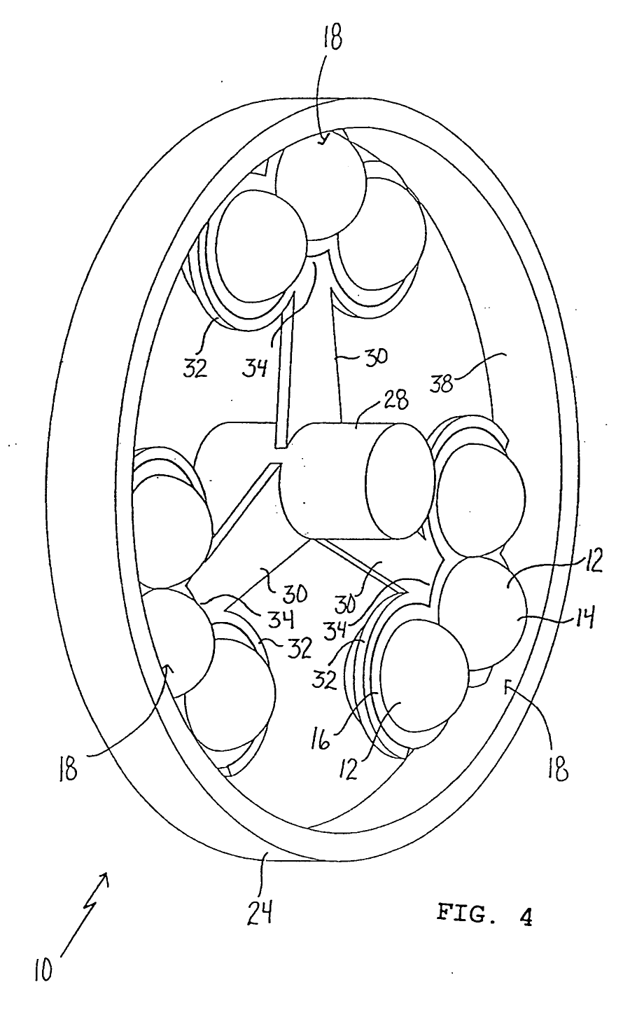

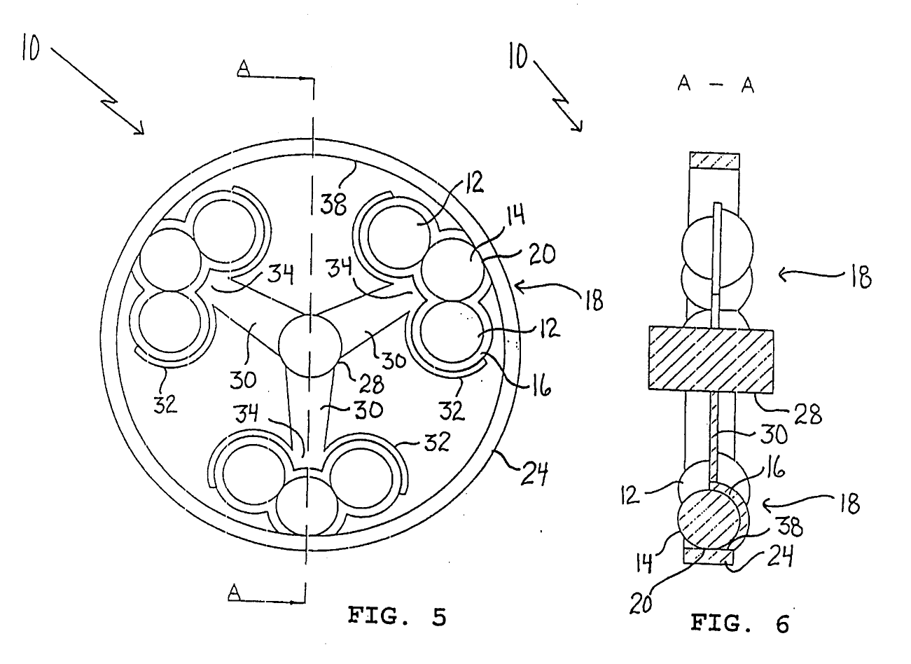

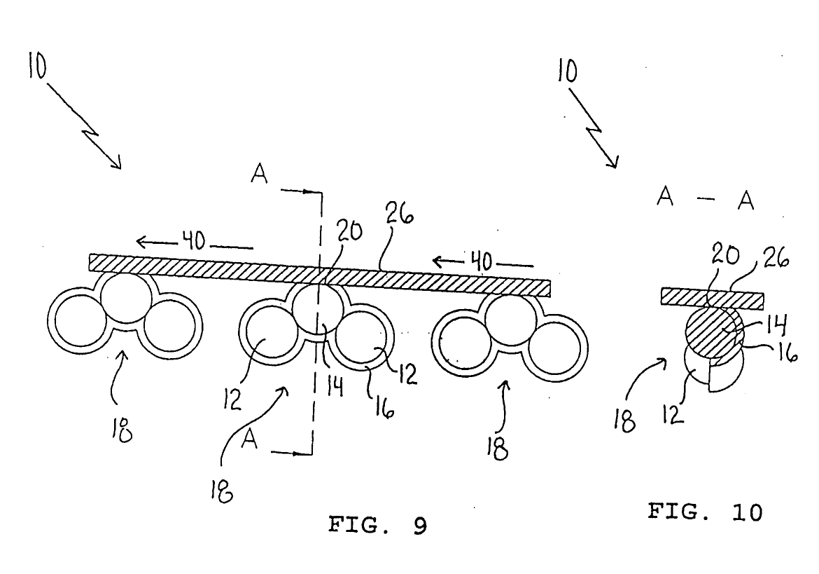

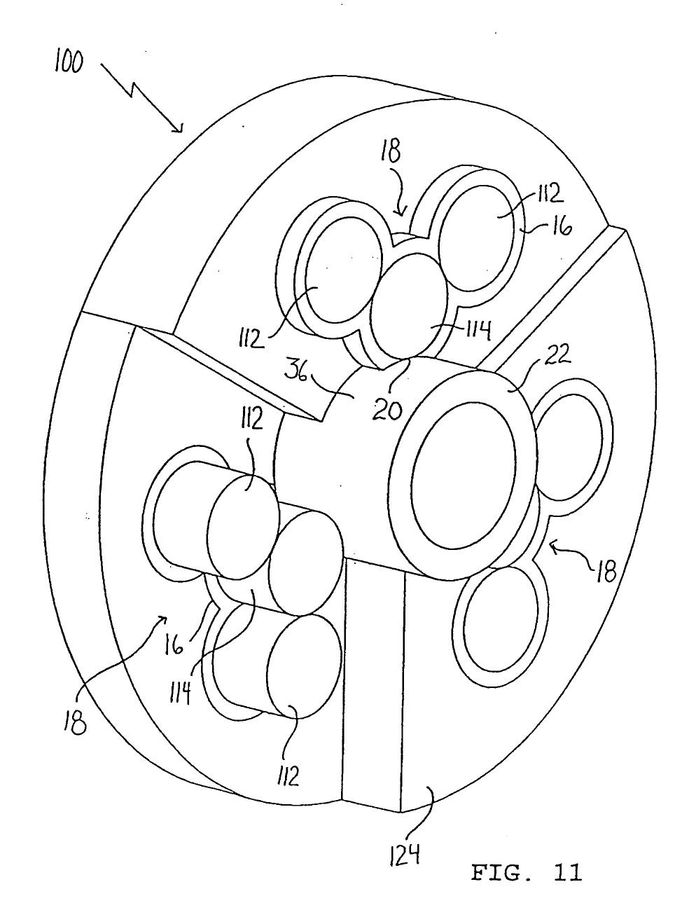

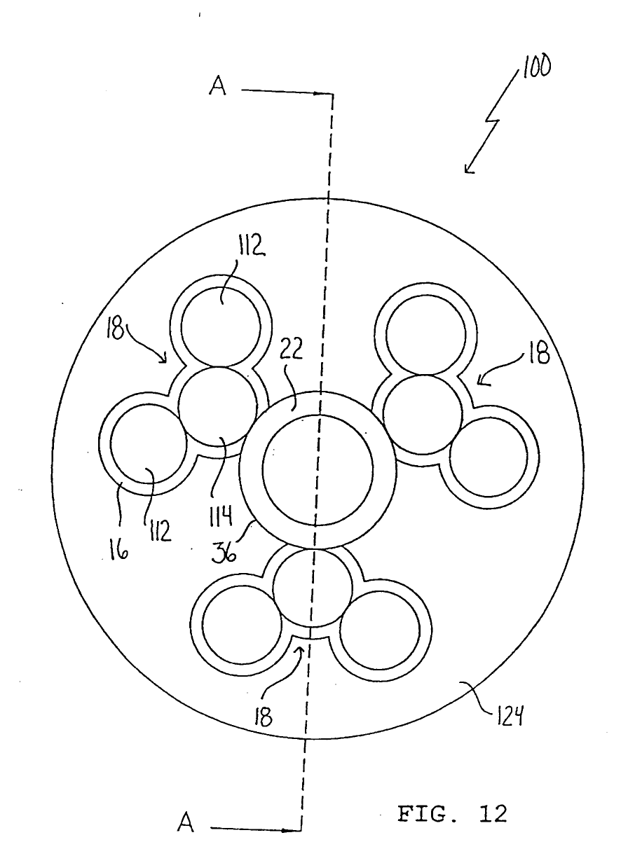

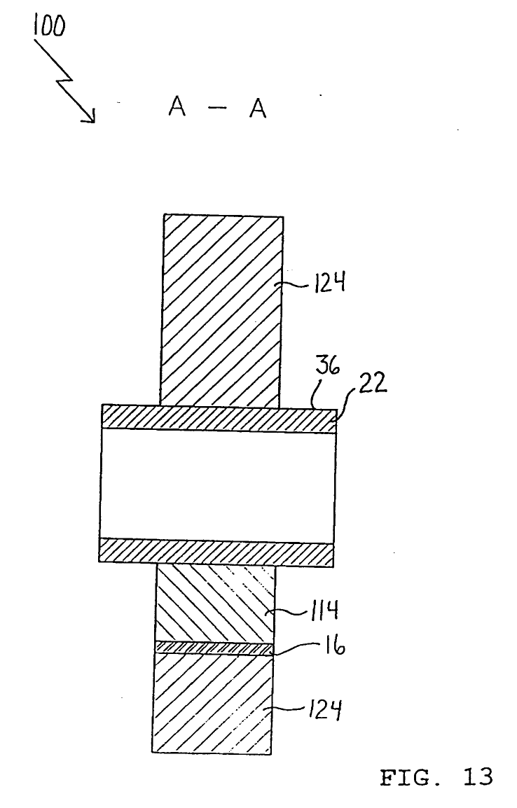

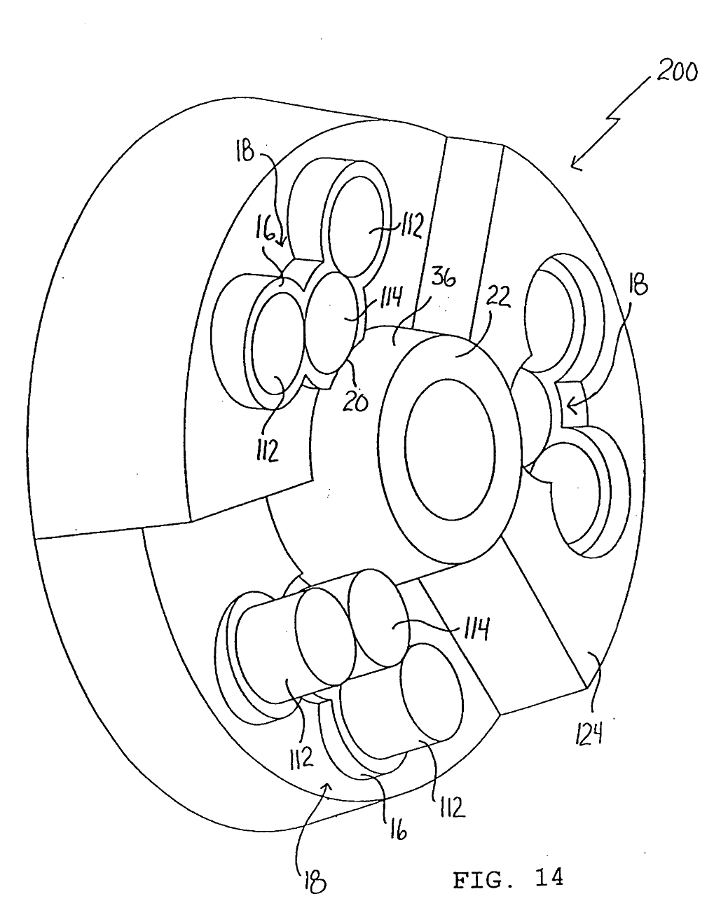

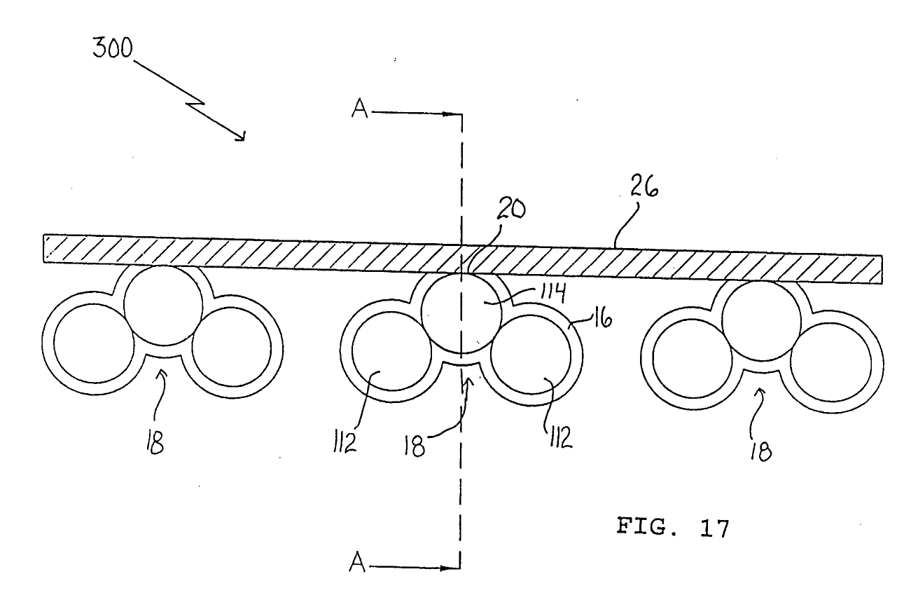

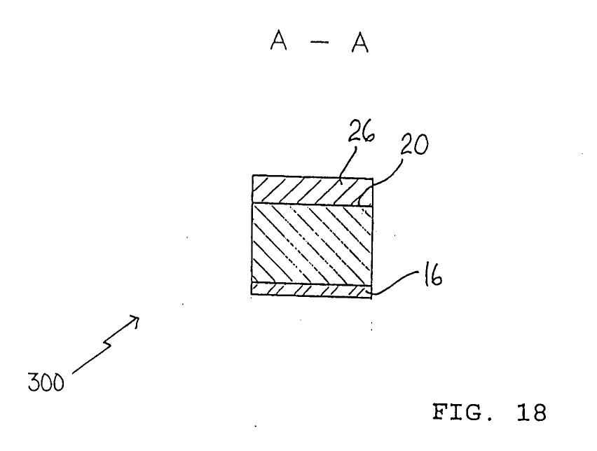

The preferred embodiment, a modular support system for moving components generally identified by reference numeral 10, will now be described in different applications with reference to FIGS. 1 through 18.

### Structure and Relationship of Parts

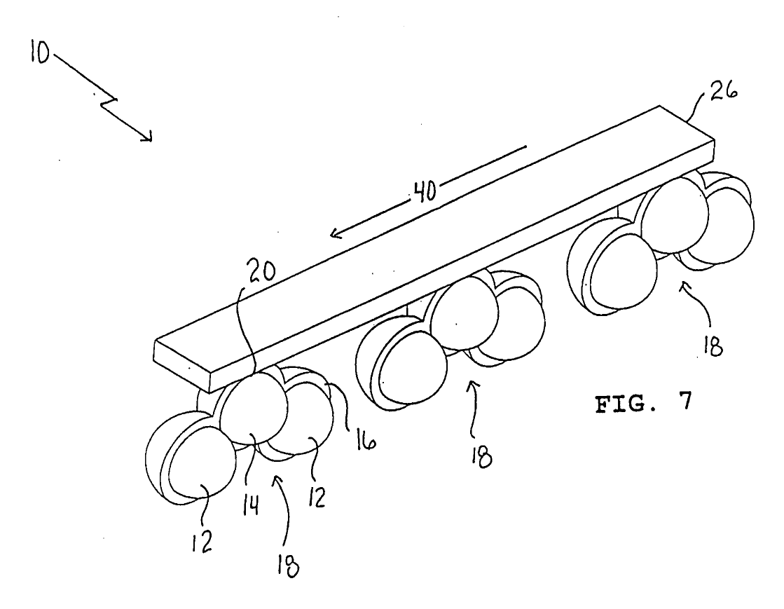

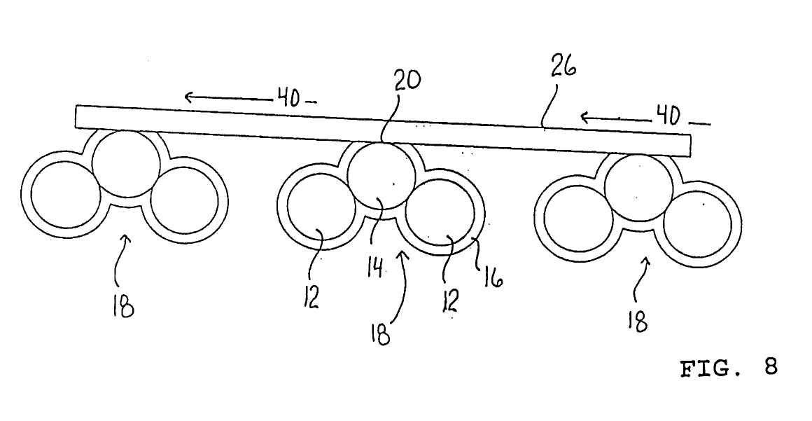

Referring to FIGS. 1, 4, and 7 modular support system 10 includes a pair of rotating support elements 12. A single rotating primary rolling element 14 is supported by support rolling elements 12. A retainer 16 is provided that is adapted to facilitate rotation while maintaining relative positioning of support rolling elements 12 and primary rolling element 14. This forms a triangular rolling element module, generally referenced by numeral 18. Primary rolling element 14 has an engagement surface 20 which protrudes from retainer 16, so that it is accessible for engagement with a moving body. In FIGS. 1 through 3, the moving body is a rotating shaft 22. In FIGS. 4 through 6, the moving body is a rotating tubular housing 24. In FIGS. 7 through 10, the moving body is a linear conveyor 26.

Referring to FIGS. 1 through 3, rotating shaft 22 rotates within a fixed housing 24. Three triangular rolling element modules 18 are supported circumferentially about rotating shaft 22 by a support frame 28 having three support arms 30 with module engaging receptacles 32 at remote ends 34 of arms 30. Engagement surface 20 of primary rolling element 14 of each triangular rolling element module 18 engages an outer surface 36 of rotating shaft 22.

Referring to FIGS. 4 through 6, rotating tubular housing 24 rotates about a fixed shaft 22. Three triangular rolling element modules 18 are supported circumferentially within rotating tubular housing 24 by a support frame 28 having three support arms 30 with module engaging receptacles 32 at remote ends 34 of arms 30. Engagement surface 20 of primary rolling element 14 of each triangular rolling element module 18 engages an inner surface 38 of rotating tubular housing 24.

Although the use of the modular support system 10 has been described above in use with rotating bodies, it is important to recognize that modular support system 10 can also be used with bodies which move in a linear fashion. Referring to FIGS. 7 through 10, there is illustrated modular support system 10 consisting of triangular roller element modules 18, as described above, in use with a moving conveyor 26. Conveyor 26 is moving in a linear fashion in a direction indicated by arrow 40.

Referring to FIGS. 11 though 18, there is illustrated a modular support system in which the rolling elements are elongate cylindrical rollers as opposed to ball shaped rolling elements as illustrated in FIGS. 1 through 10. For ease of explanation the components the subsequent embodiments detailed in FIGS. 11 through 18 below will be identified by the same reference numerals as used in the description of first embodiment 10 above, so that only the differences need to be identified and specifically described.

Referring to FIGS. 11 through 13 there is illustrated a second embodiment 100 of modular support system for moving components, which is similar to first embodiment 10 except that instead of ball shaped rolling elements, second embodiment 100 includes a pair of support cylindrical rollers 112 which support a single primary cylindrical roller 114. Primary cylindrical rollers 114 and support cylindrical rollers 112 are oriented to withstanding radial loading. As with first embodiment 10, retainer 16 is provided that is adapted to facilitate rotation while maintaining relative positioning of support cylindrical rollers 112 and primary cylindrical roller 114. This forms a triangular rolling element module, generally referenced by numeral 18. In second embodiment 100, triangular module 18 is illustrated as being embedded in a solid housing 124 for rotation about rotating shaft 22. As with first embodiment 10, primary cylindrical roller 114 of second embodiment 100 has an engagement surface 20 which protrudes from retainer 16, so that it is accessible for engagement with a moving body such as rotating shaft 22.

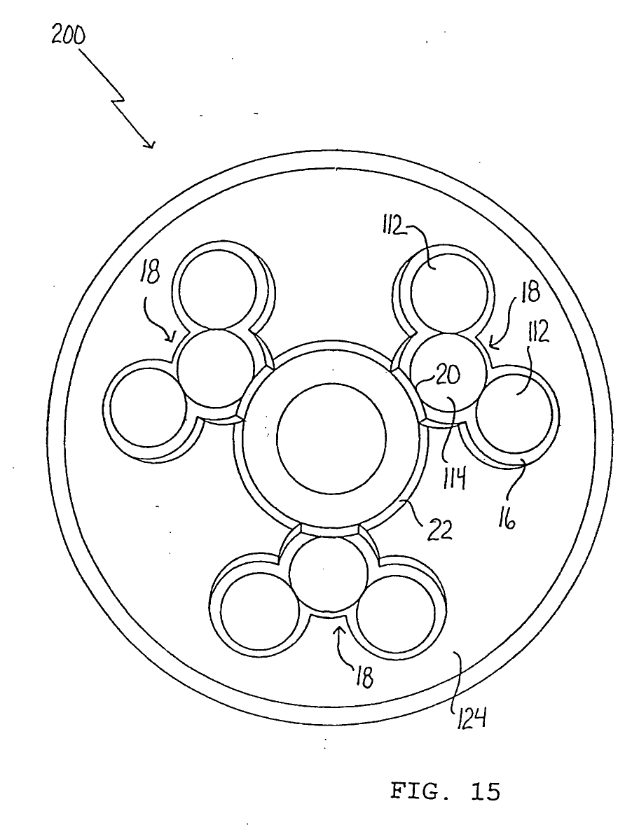

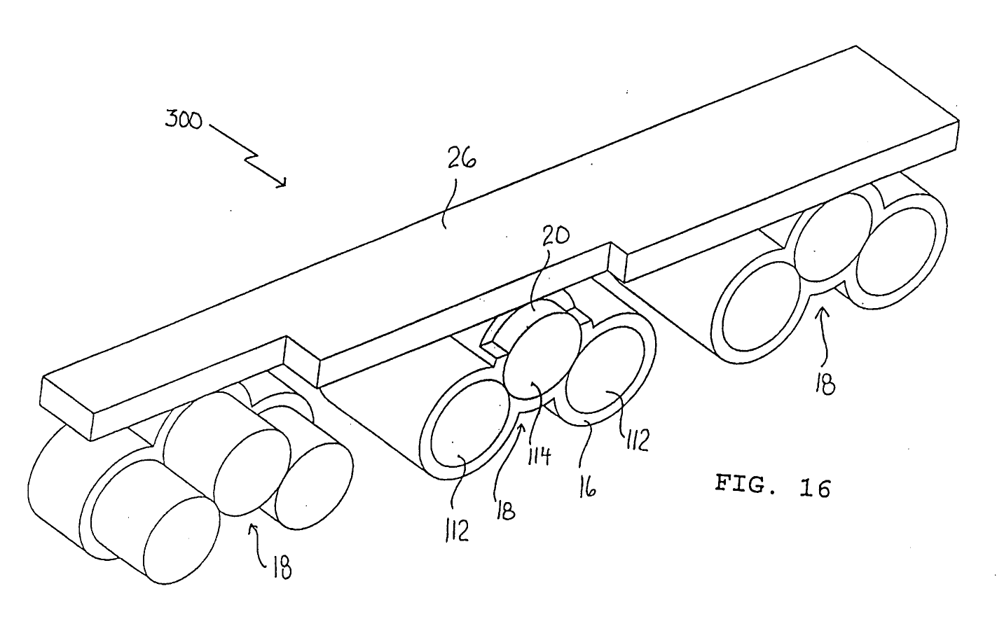

In FIGS. 14 and 15, a third embodiment 200 is illustrated. Third embodiment 200 is similar to second embodiment 100 except that support cylindrical rollers 112 and primary cylindrical rollers 114 of each triangular module 18 are oriented to withstand axial loading.

In FIGS. 16 through 18, a forth embodiment 300 is illustrated wherein primary cylindrical roller 114 of each triangular module 18 is in engagement with a moving body that is a linear conveyor 26.

### Operation

The use and operation of modular support system 10 will now be described with reference to FIGS. 1 through 18. Regardless of the application, triangular rolling element module 18 facilitates easy installation during assembly and change out during servicing. The rotation of primary rolling element 14 on support rolling elements 12 is met with relatively little resistance, making triangular rolling element modules 18 suitable for high speed applications.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1. A modular support system for moving components, comprising:
a pair of rotating support rolling elements;
a single rotating primary rolling element supported by the support rolling elements; and
a retainer adapted to facilitate rolling element rotation while maintaining relative positioning of the support roller elements and the primary rolling element, thereby forming a triangular rolling element module, an engagement surface of the primary rolling element being accessible for engagement with a moving body.

2. The modular support system for moving components as defined in claim 1, wherein the movement of the moving body is linear.

3. The modular support system for moving components as defined in claim 2, wherein the moving body is a conveyor.

4. The modular support system for moving components as defined in claim 1, wherein the movement of the moving body is rotational.

5. The modular support system for moving components as defined in claim 4, wherein the moving body is a shaft.

6. The modular support system for moving components as defined in claim 4, wherein the moving body is a tubular housing.

7. The modular support system for moving components as defined in claim 4, wherein at least three triangular rolling element modules and provided and means for supporting the at least three triangular rolling element modules circumferentially with the primary rolling element of each of the triangular rolling element modules engaging one of an outer surface of a rotating component or an inner surface of a rotating component.
